(19) United States
(12) Patent Application Publication
(10) Pub. No.: US 2008/0213522 A1
(43) Pub. Date: Sep. 4, 2008

(54) Coated Films

(75) Inventor: Shalendra Singh, Cumbria (GB)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INNOVIA FILMS LTD., Wigton Cumbria (GB)

(21) Appl. No.: 11/720,579

(22) PCT Filed: Nov. 28, 2005
(86) PCT No.: PCT/EP05/56288

§ 371 Date: Jun. 25, 2007

(30) Foreign Application Priority Data
Dec. 2, 2004 (GB) 0426561.7
Jul. 26, 2005 (GB) 0515336.6

(51) Int. Cl. B32B 27/08; B32B 1/00

(52) U.S. Cl. 428/35.7; 428/141; 428/147

(57) ABSTRACT

This invention relates to a coated polymeric film for use in a method of wrapping a ream of paper in a packaging film using a high speed, wrapping machine which is provided with tucker plates, the film having a coating on each major surface, each coated surface having a film to film COF in the range Dyn 0.30 to 0.50, one major coated surface having a coated surface to paper COF value that is greater than the COF value of the other-coated surface to tucker plate surface, the coating applied to that major surface containing an anti-blocking agent effective to regulate the COF of that surface to tucker plate surface, and greater than the quantity presenting in the coating applied to the other major surface of the film.

This invention relates to improvements in or relating to coated films, more particularly to coated thermoplastic films such as polypropylene films for use in packaging particularly as ream wrap. Ream wrap refers to packaging films for use in wrapping packages of material such as bundles of paper or groups of individual packages or cartons. Such packaging is often carried out using high speed machines running at speeds of 80 to 140 packages per minute. One problem that can occur with such machines is interpack slipping, or shingling. A further problem that occurs is so-called “pull out” which is caused by the action of a device known as a tucker plate which is used in the high speed machines.

We have now found that both slipping (or shingling) and “pull out “can be controlled by regulating the coefficient of friction (hereafter COF) of both surfaces of the film used for ream wrapping. Such adjustment we have found can be achieved by the use of particular coatings on both major surfaces of the film. There are other requirements for such films that need to be met and the coatings mast also be formulated so as to ensure the films are readily printable with solvent and water based inks. The films must also be resistant to thermal and humidity blocking. Blocking is the term used to describe the adhesion together of two film surfaces when contacted with each other e.g. within a reel of film or when two packages wrapped in a film are placed, in contact with one another. Blocking is tested by placing one layer of film in contact with another under a load. Thermal blocking is tested by applying a load of 0.5 psi for 1 hr at 60° C. to see whether blocking occurs. Tropical blocking is tested by applying the same load at 40° C. for 48 hours at 90% RH. For both tests, the force to separate a 25 mm strip cut from the film is measured using a “Davenport Blocking Balance.”

A preferred material to be coated is polypropylene, particularly polypropylene film that has been oriented or biaxially oriented. Biaxially oriented polypropylene film can be formed as multilayer film with a core of a homo-polymer of polypropylene with a skin layer formed on each side or major surface of the core. Such skin layers may be formed from copolymers such as copolymers of propylene and ethylene, or a terpolymer of propylene, ethylene and butylene. In order to achieve satisfactory adhesion of any coating to the skin layers, it is necessary to treat them with a primer before any coating is applied. Such primers include polyethyleneimine. The term BOPP will be used hereinafter to refer a film consisting of a core layer of a homo-polymer of polypropylene with skin layers formed from a copolymer or terpolymer or mixtures thereof, the skin layers having been treated with a primer. For avoidance of doubt, copolymer includes a block copolymer.

We have taught in our copending application GB042651.7 filed 2 Dec. 2004 how to achieve a coating with a COF in the range 0.30 Dyn to 0.50 Dyn while also obtaining a coating with a wide heat seal range. (Dyn is used to indicate that the Dynamic coefficient of friction is referred to). The use of coatings with a COF in this range has enabled us to control the problem of ‘shingling’. In the case of the problems arising from the use of a tucker plate, we have realised that it is important to consider not only the COF film to film but also film to paper COF, and film to metal COF. In addition one side of the film may be printed and in some cases that printed surface covered with an over lacquer. Thus, the film surface contacting paper may be a printed surface, a printed surface coated with an over lacquer or a coating capable of forming a heat seal. We have found that as long as one ensures that the COF of the film surface contacting paper exceeds that of the film surface contacting the tucker plate surface, problems due to pull out are substantially reduced or eliminated.

During the wrapping of a packaging film around a ream of paper and the transfer to stock of the packaged ream, there are three surface to surface sliding contacts where it is necessary to ensure that the relative values of the coefficient of friction of such surface to surface sliding contacts are such as to eliminate or substantially alleviate problems such as shingling and “pull out”.

These surface to surface sliding contacts are:
A. The contact between one package and another i.e. the sliding contact between an outside surface of the film wrapped about one package with an outside surface of the film wrapped about another package.
B. The contact between a surface of the film as it is tucked in to form an end of a package with the paper surface.
C. The contact between a surface of the film as it is tucked in to place to form an end of a package with a surface of a device such as a tucker plate that is used in machines designed to package a ream of paper in a packaging film.

The term film surface is used to refer to any state of the film surface as it is fed from a reel to a machine designed to package a ream of paper in a packaging film. This state will he dictated by the treatment the film has received before being fed to the machine. Thus the film surface may have been:

(1) coated with a heat sealable coating;

(2) printed: and/or

(3) coated with an over-lacquer.

References to the paper surface refer to any state of the surface of a paper being packaged e.g. the paper may be a coated paper.

References to a tucker plate surface refer to any state of the surface that contacts the packaging film during the tucking operation. This maybe simply a metal surface such as stainless steel, or a coating applied to improve the operation of the tucker plate or to reduce wear.

We have now found that for an efficient and economic operation of a machine ream wrapping paper with packaging film, and in particular to eliminate or substantially reduce the loss of production through the problems known as ‘shingling’ and ‘pull out’ it is necessary to ensure that the COF of film surface to paper surface is greater than the COF of film surface to tucker plate surface.

According to the invention, there is provided a coated polymeric film for use in a method of wrapping a ream of paper in a packaging film using a high speed wrapping machine which is provided with tucker plates, the film having a coating on each major surface, each coated surface having a film to film COF in the range Dyn 0.30 to 0.50, one major coated surface having a coated surface to paper COF value that is greater than the COF value of the other coated surface to tucker plate surface, the coating applied to that major surface containing a quantity of an anti-blocking agent to regulate the COF of that surface to tucker plate surface, the quantity being more than is needed to prevent blocking, and greater than the quantity presenting in the coating applied to the other major surface of the film.

The anti-blocking agent used to regulate the COF of the coated surface to tucker plate surface is preferably in the form of spherical particles of polymethylmethacrylate (pmma). The amount of such spherical particles present in the coating composition is preferably in the range 0.5 to 2.5 per cent by weight of the coating.

The spherical particles are preferably selected so that the particle size distribution is such that the diameters of the particles are in the range 4 to 12 microns with a median size of about 5 to about 7, preferably about 6 microns.

It is also possible to use pmma particles in the form of a flake with an aspect ratio of 2to 1. We prefer to use such flakes with an average particle size between about 7 and about 9 microns, for example from about 7.5 to about 8 microns.

Either form of pmma may be used in the coating composition as both an anti-blocking agent and to adjust the COF of the surface of the film that contacts a tucker plate surface. We prefer to use a mixture of both forms of pmma, as exemplified in Example 2 below, in the composition applied to the film surface that contacts a tucker plate surface, and the flake form in the composition applied to the other major surface of the film. The quantities used in the coating compositions applied to the film surface that contacts a tucker plate surface will vary according to the COF or COF range to be attained and is easily determined, by experiment but the quantity in the coating formed on a film surface is unlikely to be less than about 0.25 per cent by weight of the coating nor more than about 3.5 per cent by weight, preferably not less than about 0.5 per cent by weight of the coating nor more than about 2.5 per cent by weight.

Other anti-blocking agents such as silica may be used instead of pmma particles or in admixture with pmma particles.

The quantity of anti-blocking agent added to the composition used to coat the major surface of the film that does not come into contact with a tucker plate will usually result in a coating with less than about 1.5, preferably less than about 1 per cent by weight of the coating consisting of an anti-blocking agent.

Our invention is also directed to a coated polymeric film for use in a method of wrapping a ream of paper in a packaging film having a coating on each side using a high speed wrapping machine which is provided with tucker plates, each coated side having a coefficient of friction in the range Dyn 0.30 to Dyn 0.50, and each coated side being readily printable with solvent and water based inks and resistant to thermal and humidity blocking, the coatings having been formed from a composition in which a blend of an acrylic copolymer capable of forming a heat seal and an ethylene acrylic acid copolymer forms from at least about 80 to about 99.5 per cent by weight of the entire coating, preferably from about 90 to about 99 weight per cent of the entire coating, one coated side having a COF film to paper value that is greater than the COF value of the other side to a tucker plate surface.

The coating may contain about 1 to 10 weight per cent of a wax such as carnuba wax or montan wax.

The composition may also contain an anti-blocking agent, usually less than one weight per cent may also be present. Anti-blocking agents that can be used include PMMA (Poly Methyl Methacrylate) particles and Silica.

We prefer to form the coatings on each side of a BOPP film.

The quantities of acrylic copolymer and ethylene acrylic acid copolymer used are related to the need to achieve:
(a) a COF value for each surface in the range Dyn 0.30 to Dyn 0.50 preferably 0.35 to 0.40;
(b) a wide heat seal range for example in the range 80° C to 140° C.;
(c) satisfactory printing with both water based and solvent based inks; and/or
(d) optical clarity.

It has been found possible by using blends of acrylic copolymer and ethylene acrylic acid copolymer to achieve the desired values of coefficient of friction while still maintaining a wide heat seal range and the other desired properties.

The COF at the interface between any surface with a coated film surface can be adjusted by changes in the composition of the coated surface. This can be done e.g. by adjusting the quantity of anti-blocking agent present in the coating. Adding a larger than usual quantity to the coating applied to the outside surface of the film i.e. the surface that contacts the tucker plate, the interaction between the tucker plate and the coated outside surface of the film can be reduced while still maintaining a level of Coefficient of Friction film surface to film surface in the range 0.30 Dyn to 0.50 Dyn necessary to overcome shingling when ream wrap packages are being formed on high speed wrapping machines at speeds of the order of 140 packages per minute.

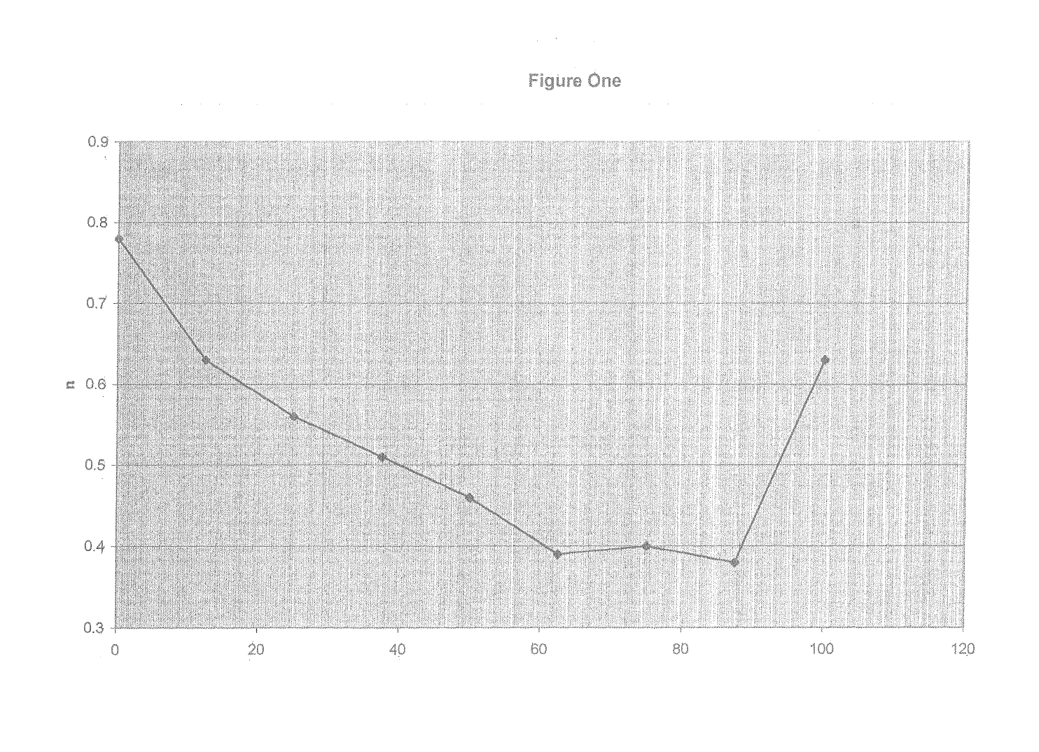

FIG. 1 is a plot of a graph which shows heat seal temperature or seal threshold temperature at which the seal strength of the film reaches 200 g/25 mm for coatings as the amount of acrylic copolymer present with an ethylene acrylic acid copolymer is varied from 0% to 100%. Composition of the coating is plotted along the X-axis and heat seal temperature along the Y-axis.

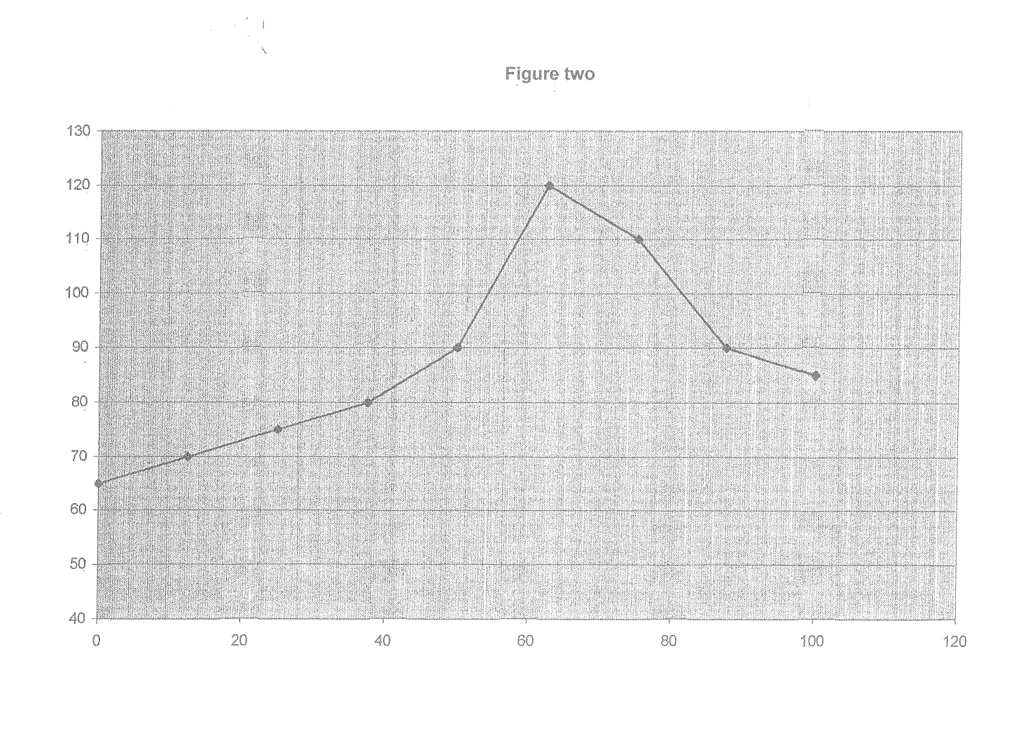

FIG. 2 is a plot of a graph which shows the change in the COF of a coated film as the amount of acrylic copolymer present with an ethylene acrylic acid copolymer is varied from 0% to 100%. Composition of the coating is plotted along the X-axis and dynamic Coefficient of Friction along the Y-axis.

The coating compositions used in observing the change in both heat seal temperature and coefficient of friction are set out in Table 1 below in which the quantities of each component are in gms.

TABLE ONE

| Components | | | | | | | | |
|---|---|---|---|---|---|---|---|---|
| % acrylic | 100 | 75 | 62.5 | 50 | 37.5 | 25 | 12.5 | 0 |
| polymer | | | | | | | | |
| WB1240 | 375 | 281.3 | 234.4 | 187.5 | 140.6 | 988 | 469 | 1000 |
| Aquaseal 1290 | 0 | 250 | 375 | 500 | 625 | 750 | 875 | 0 |
| water | 625 | 468.8 | 390.6 | 312.5 | 234.4 | 156.3 | 78.1 | 0 |
| % solids | 15 | 15 | 15 | 15 | 15 | 15 | 15 | 15 |

WB1240 is an acrylic copolymer dispersion in water supplied by Cytec Surface Specialities of Rue d'Anderlect 33 B-1620 Drogenbos Belgium. Aquaseal 1290 is a dispersion of an ethylene acrylic acid copolymer supplied by Paramelt BV Costerstraat 18, P.O. Box 86, NL-1700 AB Heerhugowaard.

The preferred heat seal range is that achieved using 20 to 50 weight per cent of acrylic copolymer and 50 to 80 weight per cent of the ethylene acrylic acid polymer. Most preferably the blend of polymers used in the coating is an acrylic copolymer content of about 35 weight per cent and an ethylene acrylic acid copolymer content of about 60 weight per cent. It will be seen from figure two that choosing a blend in the same composition range as that preferred for heat seal strength results in a coated film with a COF within the preferred range of Dyn 0.35 to 0.40. The figure also shows how the use of a blend results in an increase in the COF in comparison with the use of either component on its own.

We have further found that at coating weights of the order of 1 gsm and where a heat scalable coating is based on a blend of an acrylic copolymer and an ethylene-acrylic acid polymer whose composition is chosen so that the film to film COF is in the range 0.30 Dyn to 0.50 Dyn and is applied to a BOPP film in which the skin layers are formed from a propylene ethylene block co-polymer, a sealed ream wrap package can be formed with so called peelable seal.

The acrylic polymer is chosen from acrylic polymers that are supplied for use in heat scalable coatings such as styrene acrylic polymers.

Ethylene-acrylic acid is, typically, produced by high pressure copolymerization of ethylene and acrylic acid. When ethylene is copolymerized with acrylic acid, the molecular structure is significantly altered by the random inclusion of bulky carboxylic acid groups along the backbone and side chains of the copolymer. The carboxyl groups are free to form bonds and interact with any poly substrate. The films are coated at coating weights in the range 0.5 to 1.5 g/m², preferably 1 gsm.

The following examples in which all parts are percentage parts by weight illustrate but do not limit the invention.

### EXAMPLE 1

Part 1

A coated film was produced by applying a coating composition by a gravure process to both sides of a BOPP film at a coating weight of 1 g/m² and dried the coating in an oven. The coating composition contained:

Ethylene acrylic acid copolymer (Aquaseal 1290) 60%;

Acrylic copolymer (WB1240) 35%; and

Carnauba wax 5%,

The coating was applied as an aqueous dispersion which had a 15% solids content.

The COF of each side was measured by the sliding sledge method using a sliding plane tester supplied by Specialist Engineering Unit 2,KnelIa Road Industrial Estate Welwyn Garden City Herts UK. The measurement were made immediately after coating and after one month on film taken from reels that had been rewound and slit. It was found that alter coating the COF value for both sides of the film was 0.45 and after one month 0.35. Further testing after an elapse of six weeks showed no substantial change in COF.

Blocking was tested and the film performance was satisfactory. Testing of the heat seal properties showed a gradual increase in heat seal strength with temperature. Samples tested for printability produced an acceptable print quality.

Part 2

The static and dynamic COF values film to paper, and film to metal were determined for both sides of further samples of BOPP film coated with the same composition as was used in part one of this example. The samples having been coated four weeks before testing. The paper was an A4 copying paper. The results are shown in Table 2.

TABLE 2

| | Side 1 | | Side 2 | |
|---|---|---|---|---|
| | Static | Dynamic | Static | Dynamic |
| Film to paper | 0.36 | 0.30 | 0.38 | 0.31 |
| Film to metal | 0.30 | 0.29 | 0.29 | 0.28 |

Samples of the film were used to wrap reams of paper using a high speed wrapping machine with no loss of product being experienced due to shingling and a substantial reduction in the loss of product due to pull out.

### EXAMPLE 2

A coated BOPP film was produced with an aqueous composition used to coat one side of the film containing a higher quantity of anti-blocking agent than the aqueous composition used to coat the other side. The BOPP film had been primed with a polyethyleneimine primer on both surfaces before the coating compositions were applied. The composition containing die higher quantity of anti-blocking agent was applied to the film on the side which when the film is used in wrapping reams of paper contacts the tucker plate surface i.e. the outside surface. This was so that the interaction between the tucker plate and the film surface during wrapping could be reduced.

The composition used to coat the inside surface was:

Ethylene acrylic acid copolymer (Aquaseal 1290) 6038%;

Acrylic copolymer (WB1240) 3537%: and

Carnauba wax 4%: and

polymethylmethacrylate anti-block particles in flake form 0.25%.

The coating was applied as an aqueous dispersion which had a target solids content of 19.5% solids content.

The composition used for the outside surface was

Ethylene acrylic acid copolymer (Aquaseal 1290) 59.38%:

Acrylic copolymer (WB1240) 34.37%:

Carnauba wax 4%;

Polymethylmethacrylate anti-block particles in flake form 0.25%: and

Polymethylmethacrylate anti-block 2.0% (spherical particles having a diameter size distribution in the range 4 to 12 microns with a median size of about 6 microns).

The coating applied as an aqueous dispersion which had a target solids content of 19.5%.

Two reels of film were manufactured and the COF values measured for samples taken from each reel. The variation in COF values from one reel to another for the same surface to surface measurement is within the usual limits experienced in measuring COF. The results are shown in Tables 3 and 3a.

TABLE 3

| | Side one | | Side two | |
|---|---|---|---|---|
| Reel One | Static | Dynamic | Static | Dynamic |
| Film to film | 0.51 | 0.43 | 0.40 | 0.30 |
| Film to paper | 0.40 | 0.34 | 0.40 | 0.32 |
| Film to metal | 0.32 | 0.30 | 0.21 | 0.21 |

TABLE 3a

| | Side one | | Side two | |
|---|---|---|---|---|
| Reel two | Static | Dynamic | Static | Dynamic |
| Film to film | 0.48 | 0.40 | 0.38 | 0.29 |
| Film to paper | 0.40 | 0.33 | 0.37 | 0.31 |
| Film to metal | 0.33 | 0.32 | 0.24 | 0.22 |

Both sample reels were used to form ream wrap packages on a high speed wrapping machine with no problems being experienced due to either ‘shingling’ or ‘pull out’.

### EXAMPLE 3

A film was coated on both sides with the following composition:

Ethylene acrylic acid copolymer (Aquaseal 1290) 60.38%:

Acrylic copolymer (WB1240) 35.37%;

Carnauba wax 4%; and

Polymethylmethacrylate anti-block particles in flake form 0.25%.

The coating was applied as an aqueous dispersion which had a target solids content of 19.5% solids content.

The COF values set out below in Tables 4 and 4a were measured for two samples of film which had been reverse printed over the above coating and then differently over lacquered on the paper contacting side.

TABLE 4

| Sample 1 | Stat COF | Dyn COF |
|---|---|---|
| film/film | 0.44 | 0.42 |
| over lacquer/over lacquer | 0.42 | 0.39 |
| over lacquer/paper | 0.37 | 0.35 |
| film/Metal | 0.26. | 0.24 |

TABLE 4a

| Sample 2 | Stat COF | Dyn COF |
|---|---|---|
| film/film | 0.42 | 0.40 |
| Over lacquer/Paper | 0.19 | 0.18 |
| film/Metal | 0.26. | 0.24 |

Films with COF's as measured above as samples one and two were used to wrap reams of paper on a high speed wrapping machine. No problems with shingling occurred with films having COF's as shown above for sample one and sample two but problems with ‘pull out’ were much greater with films having COF's as measured for sample two where the COF of the over lacquered surface contacting the paper was less than the COF of the film surface contacting the tucker plate.

1. A coated polymeric film for use in a high speed wrapping machine with tucker plates, the film having a coating on each major surface, each coated surface having a film to film coefficient of friction (COF) in the range of Dyn 0.30 to Dyn 0.50, one major coated surface having a coated surface to paper COF value that is greater than the COF value of the other coated surface to tucker plate surface, the coating applied to that major surface containing an anti-blocking agent effective to regulate the COF of that surface to tucker plate surface, and greater than the quantity presenting in the coating applied to the other major surface of the film.

2. A coated polymeric film of claim 1, wherein the anti-blocking agent used to regulate the COF of the coated surface to tucker plate surface comprises polymethylmethacrylate particles.

3. A coated polymeric film of claim 2, wherein the anti-blocking agent used to regulate the COF of the coated surface to tucker plate surface comprises polymethylmethacrylate particles in spherical form.

4. A coated polymeric film of claim 2, wherein the anti-blocking agent used to regulate the COF of the coated surface to tucker plate surface comprises polymethylmethacrylate particles are in the form of flakes.

5. A coated polymeric film of claim 2, wherein the anti-blocking agent used to regulate the COF of the coated surface to tucker plate surface comprises polymethylmethacrylate particles in an admixture of both flake and spherical forms.

6. A coated polymeric film of claim 3, wherein the spherical particles of polymethylmethacrylate have a diameter in the range 4to 12 microns with a median size of 6 microns.

7. A coated polymeric film of claim 4, wherein the flakes of polymethylmethacrylate have an aspect ratio of 2 to 1 and an average particle size of between 7.5 and 8 microns.

8. A coated polymeric film of claim 2, wherein the quantity of anti-blocking agent added is 0.5 to 2.5 per cent by weight of the coating.

9. A coated polymeric film of claim 1, wherein the film has a coating on each side, wherein each coated side having a coefficient of friction in the range Dyn 0.30 to Dyn 0.50, and each coated side being readily printable with solvent and water based inks and resistant to thermal and humidity blocking, the coatings having been formed from a composition in which a blend of an acrylic copolymer capable of forming a heat seal and an ethylene acrylic acid copolymer forms at least 90 to 99 weight per cent of the entire coating, one coated side having a COF film to paper value that is greater than the COF value of the other side to a tucker plate surface.

10. A coated polymeric film of claim 1, wherein the coatings contain about 1 to 10 weight per cent of a wax.

11. A coated polymeric film claim 10, wherein the wax used is carnauba wax or montan wax.

12. A coated polymeric film of claim 1, wherein the coating on each major surface contains 1 per cent by weight or less of an anti-blocking agent which is chosen from polymethylmethacrylate particles, and/or silica and/or other suitable anti-blocking agent in addition to any anti-blocking agent added to regulate the COF of the surface contacting a tucker plate.

13. A coated polymeric film of claim 9, wherein quantities forming the blend of acrylic copolymer and ethylene acrylic acid copolymer present in the coatings on each surface are chosen so as to achieve:
(e) a COF value for each surface in the range Dyn 0.30 to Dyn 0.50 preferably 0.35 to 0.40.
(f) a wide heat seal range in the range 80 degrees C. to 140 degrees C.
(g) satisfactory printing with both water based and solvent based inks.
(h) Optical clarity.

14. A coated polymeric film of claim 13, wherein the coatings on each surface contain a blend of 20 to 50 weight per cent of acrylic copolymer and 50 to 80 weight per cent of the ethylene acrylic acid polymer.

15. A coated polymeric film of claim 13, wherein the coatings on each surface contain a blend in which the acrylic copolymer content is about 35 weight per cent and the ethylene acrylic acid copolymer content is about 60 weight per cent.

16. A coated polymeric film of claim 1, wherein the film is a polypropylene film.

17. A coated polymeric film of claim 16, wherein the polypropylene film that has been biaxially oriented.

18. A coated polymeric film of claim 17, wherein the polypropylene film that has been biaxially oriented and has been formed as multilayer film with a core of a homo-polymer of polypropylene with a skin layer formed on each side or major surface of the core.

19. A coated polymeric of claim 18, wherein the skin layers have been formed from copolymers such as copolymers of propylene and ethylene, or a terpolymer of propylene, ethylene and butylene.

20. A coated polymeric film of claim 18, wherein the skin layers have been formed from a propylene ethylene block co-polymer.

21. A coated polymeric film of claim 1 coated at coating weights in the range 0.5 to 1.5 g /m².

22. A coated polymeric film of claim 20 coated at a coating weight of 1 .g/ m².

23. A sealed ream wrap package formed with a peelable seal by wrapping a ream of paper in a coated film as claimed in of claim 22 by means of a high speed wrapping machine.

24. A sealed ream wrap package formed by wrapping a ream of paper in a coated film of claim 1 by means of a high speed wrapping machine operating at speeds of the order of 140 packages per minute without substantial loss of product due to shingling or pull out.

25. A coated polymeric film of claim 5, wherein the flakes of polymethylmethacrylate have an aspect ratio of 2 to 1 and an average particle size of between 7.5and 8 microns.
